(19) United States
(12) Patent Application Publication
(10) Pub. No.: US 2007/0276782 A1
(43) Pub. Date: Nov. 29, 2007

(54) Information processing apparatus, database management system, control method and program for information processing apparatus

(75) Inventor: Takashi Oshiro, Tokyo (JP)

Correspondence Address: ARENT FOX LLP, 1050 CONNECTICUT AVENUE, N.W., SUITE 400, WASHINGTON, DC, 20036, US

(73) Assignee: NS SOLUTIONS CORPORATION

(21) Appl. No.: 11/802,814

(22) Filed: May 25, 2007

(30) Foreign Application Priority Data
May 26, 2006 (JP) 2006-147302

(51) Int. Cl. G06F 17/30

(52) U.S. Cl. 707/1

(57) ABSTRACT

Upon reception of a request for a DB server 1 and a DB server 2, an accepting server issues the request to both the DB server 1 and the DB server 2 simultaneously.

### CROSS-REFERENCE TO RELATED APPLICATIONS

This application is based upon and claims the benefit of priority from the prior Japanese Patent Application No. 2006-147302, filed on May 26, 2006, the entire contents of which are incorporated herein by reference.

### BACKGROUND OF THE INVENTION

1. Field of the Invention

The present invention relates to a technology for ensuring integrity or the like of data in a recording device.

2. Description of the Related Art

In recent years, due to popularization of the Internet, there is increased a possibility of suffering damage such as leakage of information, falsifying data with malicious intent, or the like based on unauthorized access such as connecting many in-company systems to the outside, and thus the importance of security in in-company systems is increasing. Accordingly, a database or the like in particular frequently handles highly confidential information of a company, and is provided with various functions regarding security and/or integrity of data.

For example, Patent Document 1 discloses a method of preventing leakage of information. Further, for example, Patent Document 2 and Patent Document 3 disclose a method of preventing falsifying of data so as to ensure the integrity of data.

Further, along with popularization of the Internet, there are increasing number of service providers which keep servers of customers and provide connection lines to the Internet as well as maintenance and/or operation services. They provide services such as a housing service to keep a server and provide a communication line and maintenance, and/or hosting to lend servers prepared by the providers themselves to customers. Facilities for providing such services are called data centers, and as data centers, there are one drawing a fast communication line in a building having excellent earthquake resistance, one having private power generating facilities and/or advanced air-conditioning equipment, and one ensuring security by entrance/leaving management using ID cards, 24-hour monitoring using a camera, and/or the like.

Moreover, in order to avoid damage to data in a time of disaster or the like, there is also performed creating a copy in a storage device at a geographically remote location. Specifically, there is a method to duplicate a computer and/or data, create the same environment with several systems in advance, and when failure occurs in a regularly used computer, take over the processing by the other computer to continue transactions.

Thus, the data centers are sufficiently prepared for physical security regarding disasters, failure in facilities themselves, entrance/leaving management, and so on. Against information leakage and data falsifying by system attackers or so-called crackers from the outside, typically a firewall is provided at an interface with the outside network so as to monitor and restrict the flow of external/internal data. Under circumstances such that chances to encounter a system attack such as unauthorized access are increasing rapidly due to popularization of the Internet, further strict measures regarding security in particular will be demanded.

To secure integrity of information and data in a database, a reliable way is to do this by duplicating the database. Specifically, integrity of data, presence of falsifying, and the like are detected by verifying consistency of data in duplicated databases. Normally, for replication (multiplication) of a database, with the purpose of keeping information the same between plural databases, there is adopted an approach to construct replica databases by copying information from a master database to other databases when updating of the information in the master database is performed.

[Patent Document 1] Japanese Patent Application Laid-open No. 2001-337918

[Patent Document 2] Japanese Patent Application Laid-open No. 2005-250720

[Patent Document 3] Japanese Patent Application Laid-open No. 2003-167774

The above-described methods and so on have been proposed for preventing unauthorized access to a database and/or assuring integrity of data, but for assuring integrity of information and data in a database as well as security (integrity of data, detection of presence of falsifying), the most reliable way is to duplicate a database and assure that consistency of data, namely, data contents are the same and operation histories are the same in respective databases.

However, normally, updating of information is performed asynchronously in the replica databases as targets of copying and in the master database, and thus there occurs a time lag until the replica databases are updated with the same information as in the master database. Therefore, even when operating normally, there occurs a period in which consistency cannot be maintained between the master database and the replica databases, and therefore it is not easy to verify the consistency reliably.

### SUMMARY OF THE INVENTION

Accordingly, an object of the present invention is to allow multiplication of data in a recording device while minimizing a time lag as in a conventional manner, and make it possible to find arid prevent unauthorized access reliably.

An information processing apparatus according to the present invention is an information processing apparatus connected via a communication line to a plurality of database servers performing processing according to a request from an external apparatus on data in a recording device, and the information processing apparatus includes a request accepting unit accepting a request for the plurality of database servers, and a request issuing unit issuing, when a request is accepted by the request accepting unit, the request to each of the plurality of database servers simultaneously.

A database management system according to the present invention is a database management system including a plurality of database servers performing processing according to a request from an external apparatus on data in a recording device, and an information processing apparatus, which are connected via a communication line, in which the information processing apparatus includes a request accepting unit accepting a request for the plurality of database servers, and a request issuing unit issuing, when a request is accepted by the request accepting unit, the request to each of the plurality of database servers simultaneously.

A control method for an information processing apparatus according to the present invention is a control method for an information processing apparatus connected via a communication line to a plurality of database servers performing processing according to a request from an external apparatus on data in a recording device, and the method includes a request accepting step of accepting a request for the plurality of database servers, and a request issuing step of issuing, when a request is accepted in the request accepting step, the request to each of the plurality of database servers simultaneously.

A program product according to the present invention is a program product for causing a computer to execute a control method for an information processing apparatus connected via a communication line to a plurality of database servers performing processing according to a request from an external apparatus on data in a recording device, and the program product causes a computer to execute a request accepting step of accepting a request for the plurality of database servers, and a request issuing step of issuing, when a request is accepted in the request accepting step, the request to each of the plurality of database servers simultaneously.

### BRIEF DESCRIPTION OF THE DRAWINGS

FIG. 1 is a diagram showing a schematic configuration a database management system according to an embodiment of the present invention;

FIG. 2A is a block diagram showing a hardware configuration of an AP server, an accepting server or a monitoring server;

FIG. 2B is a block diagram showing a hardware configuration of a DB server;

FIG. 3A is a sequence chart showing an operation during data update in a database management system in a “definite response mode”;

FIG. 3B is a sequence chart showing an operation during data update in the database management system in the “definite response mode”;

FIG. 3C is a sequence chart showing an operation during data update in the database management system in the “definite response mode”;

FIG. 3D is a sequence chart showing an operation during data update in the database management system in the “definite response mode”;

FIG. 4A is a sequence chart showing an operation during data update processing in a “quickest confirmation response mode”;

FIG. 4B is a sequence chart showing an operation during the data update processing in the “quickest confirmation response mode”;

FIG. 4C is a sequence chart showing an operation during the data update processing in the “quickest confirmation response mode”;

FIG. 4D is a sequence chart showing an operation during the data update processing in the “quickest confirmation response mode”;

FIG. 4E is a sequence chart showing an operation during the data update processing in the “quickest confirmation response mode”;

FIG. 5A is a sequence chart showing an operation during data reference processing in the “definite response mode”;

FIG. 5B is a sequence chart showing an operation during the data reference processing in the “definite response mode”;

FIG. 5C is a sequence chart showing an operation during the data reference processing in the “definite response mode”;

FIG. 5D is a sequence chart showing an operation during the data reference processing in the “definite response mode”;

FIG. 6A is a sequence chart showing an operation during data reference processing in the “quickest confirmation response mode”;

FIG. 6B is a sequence chart showing an operation during the data reference processing in the “quickest confirmation response mode”;

FIG. 6C is a sequence chart showing an operation during the data reference processing in the “quickest confirmation response mode”;

FIG. 6D is a sequence chart showing an operation during the data reference processing in the “quickest confirmation response mode”;

FIG. 6E is a sequence chart showing an operation during the data reference processing in the “quickest confirmation response mode”;

FIG. 7 is a flowchart showing processing of monitoring data centers by a DB comparator, and warning processing and communication blocking processing executed according to a monitoring result by the DB comparator;

FIG. 8 is a flowchart showing processing of monitoring data centers by a storage comparator, and warning processing and communication blocking processing executed according to a monitoring result by the storage comparator;

FIG. 9 is a flowchart showing processing of monitoring data centers by a Log comparator, and warning processing and communication blocking processing executed according to a monitoring result by the Log comparator;

FIG. 10 is a diagram schematically showing processing of comparing tables by the DB comparator;

FIG. 11A is a chart showing a history of log data outputted from a DB server; and

FIG. 11B is a chart showing a history of log data outputted from a DB server.

### DETAILED DESCRIPTION OF THE PREFERRED EMBODIMENTS

Hereinafter, preferred embodiments to which the present invention is applied will be explained in detail with reference to the attached drawings.

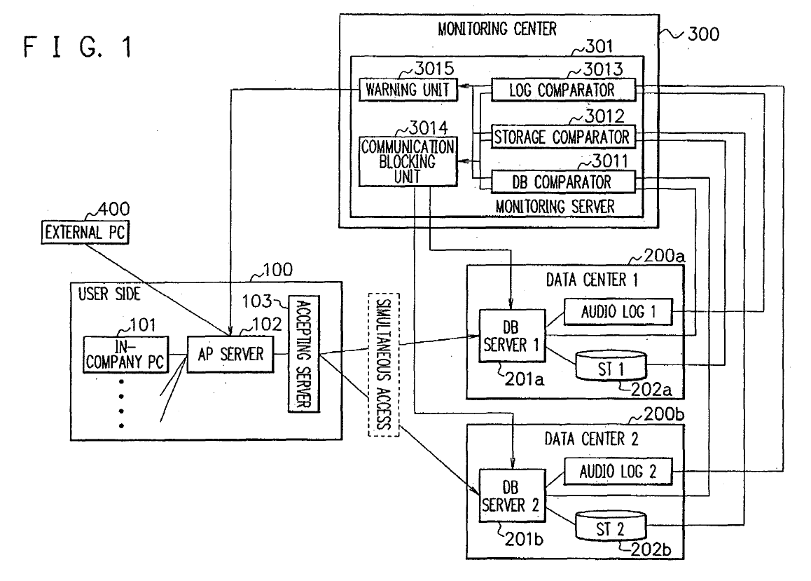

FIG. 1 is a diagram showing a schematic configuration of a database management system according to an embodiment of the present invention.

As shown in FIG. 1, in a database management system, a computer system 100 on the user side is provided with a plurality of in-company PCs 101 as client PCs, an AP (application) server 102 and an accepting server 103. The plurality of in-company PCs 101 are connected to the AP server 102 via a communication line such as LAN, and are capable of accessing the AP server 102. The AP server 102 is connected to the accepting server 103 via a communication line such as LAN. The accepting server 103 is connected to a DB server 1 (201a) and a DB server 2 (201b) in a data center 1 (200a) and a data center 2 (200b), which will be explained later, via a reliable network such as the Internet using VPN. The AP server 102 performs data communication with the DB server 1 (201a) and DB server 2 (201b) via the accepting server 103.

The AP server 102 issues a query (SQL statement) according to a request such as data update or data reference from the in-company PCs 101.

Upon reception of a query from the AP server 102, the accepting server 103 transmits the query to both the DB servers 201a, 201b simultaneously. Note that although this embodiment has a configuration in which the AP server 102 and accepting server 103 are separated, the embodiment may also have a configuration in which these functions are mounted in one server.

Also, FIG. 1 shows the configuration in which the AP server 102 is connected also to a computer outside the company (hereinafter, referred to as an external PC) 400 via the Internet. When access to the AP server 102 is permitted, access from the external PC 400 is also possible.

The data center 1 (200a) is provided with the DB (database) server 1 (201a) and a storage device 1 (202a). Similarly, the data center 2 (200b) is provided with the DB server 2 (201b) and a storage device 2 (202b). Note that although in this embodiment it is assumed that two data centers exist, a much larger number of data centers may exist.

The monitoring center 300 is provided with a monitoring server 301. The monitoring server 301 includes, as functional components, a Log comparator 3013, a storage comparator 3012, a DB comparator 3011, a warning unit 3015 and a communication blocking unit 3014, and is connected to the DB server 1 (201a) and the DB server 2 (201b) via a reliable network such as the Internet using VPN.

When the DB server 1 (202a) and the DB server 2 (202b) perform any kind of processing such as referring to data in the storage device, updating, and the like, they output log data corresponding to this processing. The Log comparator 3013 obtains the log data outputted from the DB server 1 (202a) and the DB server 2 (202b) respectively and compares them so as to detect any difference between the log data.

As described above, since the accepting server 103 transmits the same query to the DB server 1 (201a) and the DB server 2 (201b) simultaneously, the DB server 1 (201a) and the DB server 2 (201b) should exhibit the same behavior according to the query simultaneously. However, when there is detected a difference between the log data from the DB server 1 (202a) and the log data from the DB server 2 (202b) as a result of comparison by the Log comparator 3013, it is possible that there is performed unauthorized viewing of data and/or falsifying of data with respect to at least either one of the data in the storage device 1 (202a) and the data in the storage device 2 (202b) through unauthorized access. In other words, the Log comparator 3013 can detect unauthorized viewing of data and falsifying of data by comparing the log data.

The storage comparator 3012 compares all the data stored in the storage device 1 (202a) with all the data stored in the storage device 2 (202b), and detects a difference between the data in the storage device 1 (202a) and the data in the storage device 2 (202b). However, the comparison of data is performed by different methods in the case where data management is performed by a file system in the storage device 1 (202a) and the storage device 2 (202b) and in the case where the storage devices 1 (202a), 2 (202b) manage data as low devices, respectively.

Since the accepting server 103 transmits the same query to the DB server 1 (201a) and the DB server 2 (201b) simultaneously, the data in the storage device 202a and the data in the storage device 202b should match. However, when the data in the storage device 202a and the data in the storage device 202b do not match as a result of comparison by the storage comparator 3012, it is possible that there is performed unauthorized viewing of data and/or falsifying of data with respect to at least either one of the data in the storage device 1 (202a) and the data in the storage device 2 (202b) through unauthorized access. In other words, the storage comparator 3012 can detect unauthorized viewing of data and falsifying of data through the external PC 400 by comparing the data in storage devices.

The DB comparator 3011 issues the same query to both the DB server 1 (200a) and the DB server 2 (200b) simultaneously. Then, the DB comparator 3011 compares tables extracted by the DB server 1 (200a) and the DB server 2 (200b) according to the query to detect a difference between the tables.

Since the same query is transmitted to the DB server 1 (201a) and the DB server 2 (201b) from the accepting server 103 simultaneously, the data in the storage device 1 (202a) and the storage device 2 (202b) should be the same. Since the DB comparator 3011 issues the same query for extracting a table with respect to data in the storage device 1 (202a) and the storage device 2 (202b) having the same contents, the table extracted from the DB server 1 (201a) and the table extracted from the DB server 2 (201b) should match. However, when the table extracted from the DB server 1 (201a) and the table extracted from the DB server 2 (201b) do not match as a result of the comparison by the DB comparator 3011, it is possible that there is performed unauthorized viewing of data and/or falsifying of data with respect to at least either one of the data in the storage device 1 (202a) and the data in the storage device 2 (202b) through unauthorized access. In other words, the DB comparator 3011 can detect unauthorized viewing of data and falsifying of data through the external PC 400 by comparing the tables.

The comparison of log data, comparison of data in the storage devices, and comparison of tables may each be performed every time a log is generated, a change is made in data, or a query is issued, or may each be performed regularly at predetermined time periods.

The communication blocking unit 3014 transmits control information to the DB server 1 (201a) and the DB server 2 (201b) for blocking communication of the DB server 1 (201a) and the DB server 2 (201b) with the outside when a difference in log data is detected by the Log comparator 3013, when a difference in data is detected by the storage comparator 3012, or when a difference in tables is detected by the DB comparator 3011.

The warning unit 3015 transmits warning information to the AP server 102 when a difference in log data is detected by the Log comparator 3013, when a difference in data in the storage devices is detected by the storage comparator 3012, or when a difference in tables is detected by the DB comparator 3011.

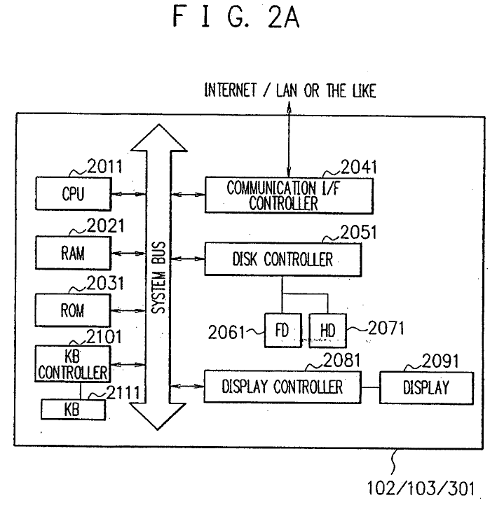

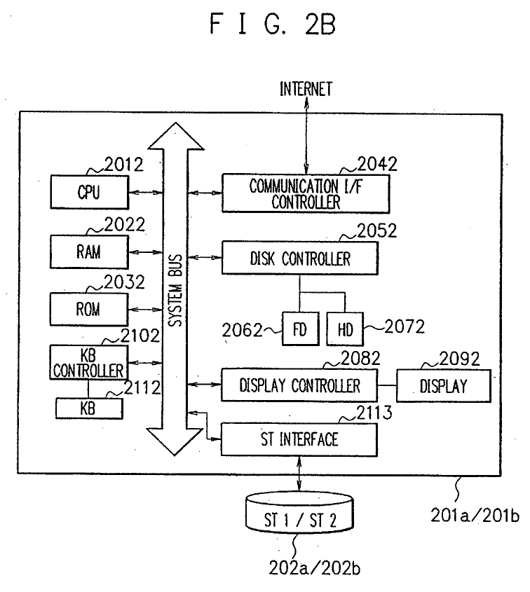

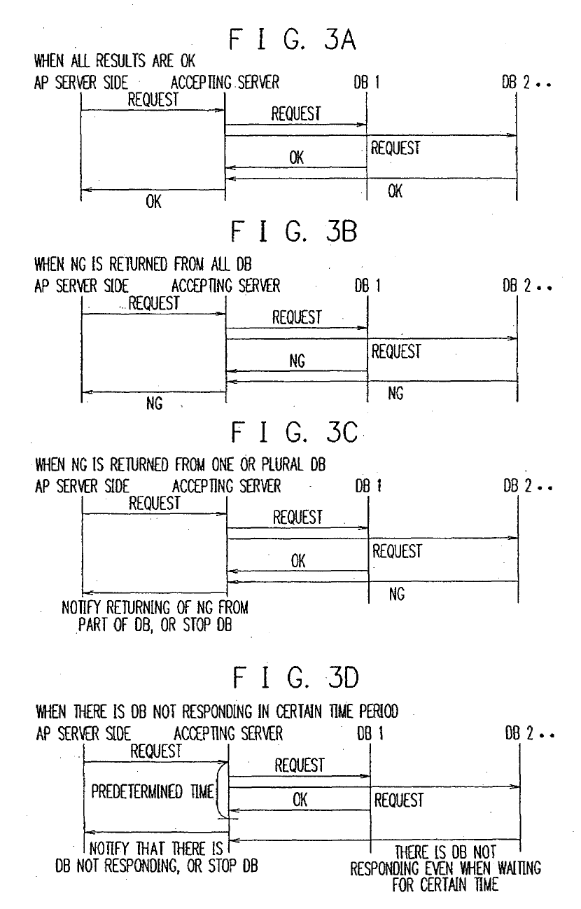

FIG. 2A is a block diagram showing a hardware configuration of the AP server 102, the accepting server 103, or the monitoring server 301. A CPU 2011 totally controls respective devices and a controller connected to a system bus. A ROM 2031 or an HD 2071 stores a BIOS (Basic Input/Output System), which is a control program for the CPU 2011, an operating system program, a program for processing executed by the AP server 102, the accepting server 103 or the monitoring server 301 shown in FIG. 3A to FIG. 6E for example, and so on.

Note that although the example of FIG. 2A shows a configuration in which the hard disk (HD) 2071 is arranged inside the AP server 102, the accepting server 103 or the monitoring server 301, another embodiment may have a configuration in which a component corresponding to the HD 2071 is arranged outside the AP server 102, the accepting server 103 or the monitoring server 301. Further, the program for executing processing shown in FIG. 3A to FIG. 6E for example according to this embodiment may be configured to be recorded in a computer readable recording medium, such as flexible disk (FD) 2061 or CD-ROM, and supplied from the recording medium, or supplied via a communication medium such as the Internet.

The RAM 2021 functions as a main memory, a work area, and/or the like for the CPU 2011. The CPU 2011 realizes various operations by loading a program or the like needed when executing processing to the RAM 2021 and by executing the program.

A disk controller 2051 controls access to the hard disk 2061 and an external memory such as flexible disk 2061. A communication IF controller 2041 connects to the Internet or a LAN and controls communication with the outside by TCP/IP for example.

A display controller 2081 controls displaying of an image in a display 2091 such as. CRT (Cathode Ray Tube).

Note that each of the Log comparator 3013, the storage comparator 3012 and the DB comparator 3011 of the monitoring server 301 is of a configuration corresponding to a program, which is stored for example in the hard disk 2071 and loaded to the RAM 2021 as necessary, and the CPU 2011 executing the program.

Further, each of the communication blocking unit 3014 and the warning unit 3015 is of a configuration corresponding to a program, which is stored for example in the hard disk 2071 and loaded to the RAM 2021 as necessary, and the CPU 2011 executing the program, and to the communication I/F controller 2041.

FIG. 2B is a block diagram showing a hardware configuration of the DB server 201a or the DB server 201b. Components 2012, 2022, 2032, 2042, 2052, 2062, 2072, 2082, 2092, 2102 and 2112 in FIG. 2B denote configurations corresponding to the components 2011, 2021, 2031, 2041, 2051, 2061, 2071, 2081, 2091, 2101 and 2111 in FIG. 2A, respectively.

An ST interface 2113 is an interface for the CPU 2012 of the DB server 201a or the DB server 201b to perform reference, update or the like of data in the storage device 202a or 202b.

Here, the HD 2072 stores the program of processing shown in FIG. 3A to FIG. 6E for example executed by the CPU 2012 of the DB server 201a or the DB server 201b, and so on. By the CPU 2012 reading a program or the like appropriately from the HD 2072 to the RAM 2022 and executing the program, the processing shown in FIG. 3A to FIG. 6E for example by the DB server 201a or the DB server 201b is executed.

Next, an example of operations of the computer system 100 on the user side and the database systems in the data center 200a, 200b will be explained.

First, with reference to FIG. 3A to FIG. 3D, operations during data update in the storage device 1 (200a) and the storage device 2 (200b) will be explained. First, an operation during data update in a “definite response mode” will be explained, in which the accepting server 103 waits for replies from all the servers, DB server 1 (201a) and DB server 2 (201b), and then responds to the AP server 102. Here, there are two DB servers for the sake of clarity, but there may be more than two DB servers.

The AP server 102 issues a query for data update (Request (Insert/Delete/Update or the like)) in response to a request for data update from an in-company PC 101. Upon reception of the query from the AP server 102, the accepting server 103 transmits the query to the DB server 1 (201a) and the DB server 2 (201b) simultaneously. Upon reception of the query, the DB server 1 (201a) and the DB server 2 (201b) reply with result information indicating whether data update processing according to the query is succeeded (OK) or failed (NG). At this time, the accepting server 103 waits for replies from both the DB server 1 (201a) and the DB server 2. (201b), and responds to the AP server 102 according to reply contents from the DB server 1 (201a) and the DB server 2 (201b).

As shown in FIG. 3A, when both the DB server 1 (201a) and the DB server 2 (201b) reply with result information indicating that the data update processing is succeeded (OK), the accepting server 103 responds to the AP server 102 that the data update processing is succeeded (OK) after receiving the replies from both the DB server 1 (201a) and the DB server 2 (201b). In this manner, in the “definite response mode”, a success of data update processing is notified to the AP server 102 after the success of the data update processing is confirmed in both the DB server 1 (201a) and the DB server 2 (201b).

Further, as shown in FIG. 3B, when both the DB server 1 (201a) and the DB server 2 (201b) reply with result information indicating that the data update processing is failed (NG), the accepting server 103 responds to the AP server 102 that the data update processing is failed (NG) after receiving the replies from both the DB server 1 (201a) and the DB server 2 (201b). In this manner, in the “definite response mode”, a failure of data update processing is notified to the AP server 102 after the failure of the data update processing is confirmed in both the DB server 1 (201a) and the DB server 2 (201b).

Further, as shown in FIG. 3C, when the DB server 1 (201a) replies with result information indicating that the data update processing is succeeded (OK), but the DB server 2 (201b) replies with result information indicating that the data update processing is failed (NG), the accepting server 103 responds to the AP server 102 that the data update processing is failed (NG) after receiving the replies from both the DB server 1 (201a) and the DB server 2 (201b). In this manner, in the “definite response mode”, when a success of data update processing is notified first from the DB server 1 (201a) but thereafter a failure of data update processing is notified from the DB server 2 (201b), the accepting server 103 notifies the failure of the data update processing to the AP server 102. At this time, the accepting server 103 may transmit to the DB server 1. (201a) and the DB server 2 (201b) control information to stop both the DB server 1 (201a) and the DB server 2 (201b).

Further, as shown in FIG. 3D, when the DB server 1 (201a) replies with result information indicating that the data update processing is succeeded (OK) in a certain time period passed from the time point of receiving the query from the AP server 102 but there is no reply from the DB server 2 (201b) in that certain time period, the accepting server 103 responds to the AP server 102 that there is no reply from the DB server 2. In this manner, in the “definite response mode”, when a success of data update processing is notified from the DB server 1 (201a) in a certain time period but there is no reply from the DB server 2 (201b) in the certain time period, the accepting server 103 notifies only the absence of reply from the DB server 2 (201b) to the AP server 102. At this time, the accepting server 103 may transmit to the DB server 1 (201a) and the DB server 2 (201b) control information to stop both the DB server 1 (201a) and the DB server 2 (201b). In short, in the “definite response mode”, notification of success or failure to the AP server is performed upon reception of results of processing from all the DB servers.

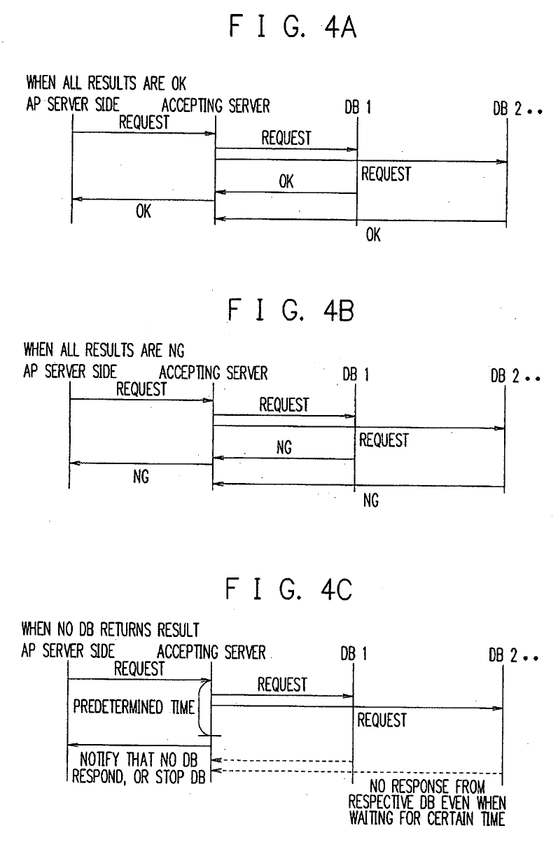

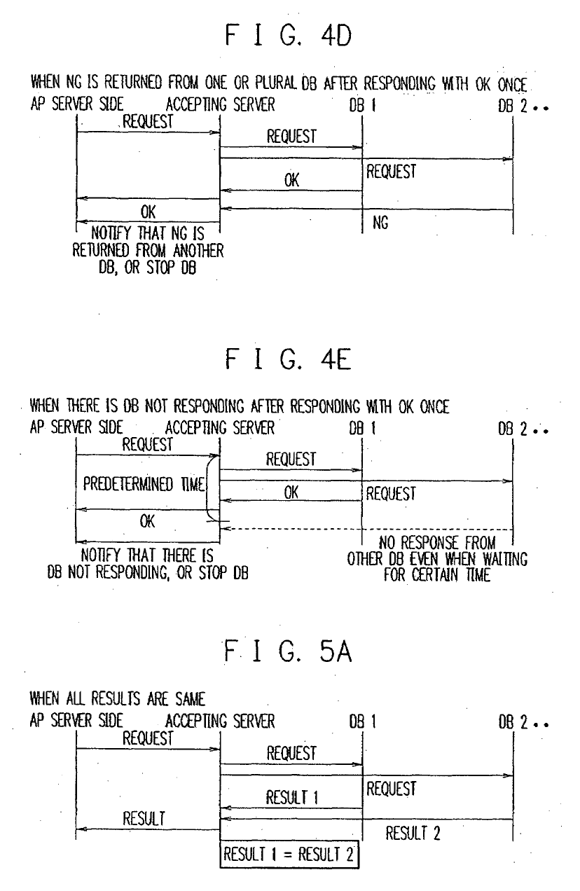

Next, with reference to FIG. 4A to FIG. 4E, operations during data update processing in a “quickest confirmation response mode” will be explained, in which the accepting server 103 responds to the AP server 102 at the time point when there is a reply first from either the DB server 1 (201a) or the DB server 2 (201b).

The AP server 102 issues a query (Request (Insert/Delete/Update or the like)) in response to a request for data update from an in-company PC 101. Upon reception of the query from the AP server 102, the accepting server 103 transmits the query to the DB server 1 (201a) and the DB server 2 (201b) simultaneously. Upon reception of the query, the DB server 1 (201a) and the DB server 2 (201b) reply with result information indicating whether data update processing according to the query is succeeded (OK) or failed (NG). At the time point when there is a reply from either one of the DB server 1 (201a) and the DB server 2 (201b), the accepting server 103 responds to the AP server 102 according to reply contents thereof.

As shown in FIG. 4A, when the DB server 1 (201a) replies first with result information indicating that the data update processing is succeeded (OK) and thereafter the DB server 2 (201b) replies also with result information indicating that the data update processing is succeeded (OK), the accepting server. 103 responds to the AP server 102 that the data update processing is succeeded (OK) according to reply contents from the DB server 1 (201a) without waiting for the reply from the DB server 2 (201b).

Further, as shown in FIG. 4B, when the DB server 1 (201a) replies first with result information indicating that the data update processing is failed (NG) and thereafter the DB server 2 (201b) replies also with result information indicating that the data update processing is failed (NG), the accepting server 103 responds to the AP server 102 that the data update processing is failed (NG) at the time point of receiving a reply from the DB server 1 (201a) without waiting for the reply from the DB server 2 (201b).

Further, as shown in FIG. 4C, when there is no reply from either the DB server 1 (201a) or the DB server 2 (201b) during a certain time period passed from the time point of receiving the query from the AP server 102, the accepting server 103 responds to the AP server 102 that there is no reply from either the DB server 1 (201a) or the DB server 2 (201b). At this time, the accepting server 103 may transmit to the DB server 1 (201a) and the DB server 2 (201b) control information to stop both the DB server 1 (201a) and the DB server 2 (201b).

Further, as shown in FIG. 4D, when the DB server 1 (201a) replies first with result information indicating that the data update processing is succeeded (OK) and thereafter the DB server 2 (201b) replies with result information indicating that the data update processing is failed (NG), the accepting server 103 responds to the AP server 102 that the data update processing is succeeded (OK) at the time point when there is a reply from the DB server 1 (201a), and thereafter responds to the AP server 102 that the data update processing is failed (NG) at the time point when a reply from the DB server 2 (201b) is received. At this time, the accepting server 103 may transmit to the DB server 1 (201a) and the DB server 2 (201b) control information to stop both the DB server 1 (201a) and the DB server 2 (201b).

Further, as shown in FIG. 4E, when the DB server 1 (201a) replies with result information indicating that the data update processing is succeeded (OK) in a certain time period passed from the time point of receiving the query from the AP server 102 but there is no reply from the DB server 2 (201b) in that certain time period, the accepting server 103 responds to the AP server 102 that the data update processing is succeeded at the time point when there is a reply from the DB server 1 (201a), and responds to the AP server 102 that there is no reply from the DB server 2 (201b) after the certain time period passes. At this time, the accepting server 103 may transmit to the DB server 1 (201a) and the DB server 2 (201b) control information to stop both the DB server 1 (201a) and the DB server 2 (201b).

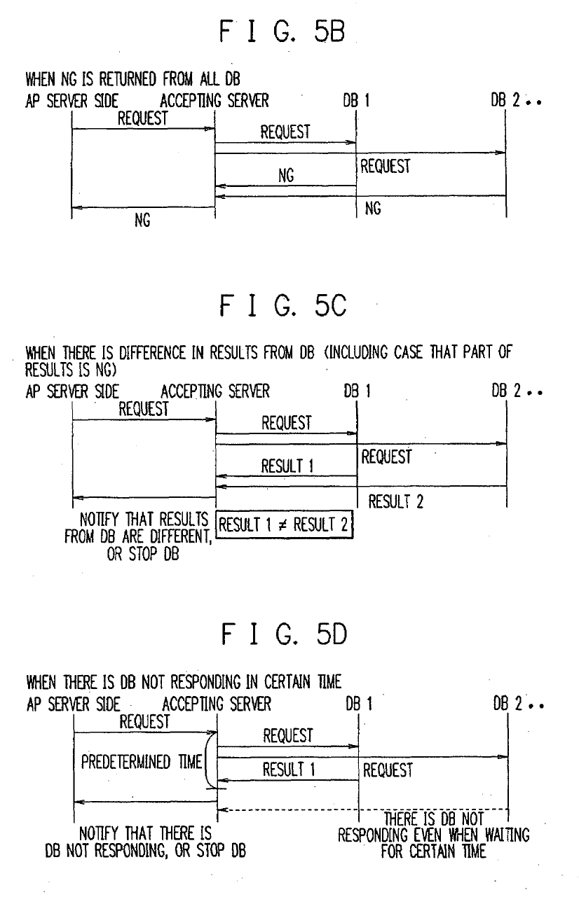

Next, with reference to FIG. 5A to FIG. 5D, operations during data reference in the storage device 1 (200a) and the storage device 2 (200b) will be explained. First, an operation during data reference processing in the “definite response mode” will be explained, in which the accepting server 103 waits for replies from all the servers, DB server 1 (201a) and DB server 2 (201b), and then responds to the AP server 102.

The AP server 102 issues a query for data reference (Request (Select or the like)) in response to a request for data reference from an in-company PC 101. Upon reception of the query from the AP server 102, the accepting server 103 transmits the query to the DB server 1 (201a) and the DB server 2 (201b) simultaneously. Upon reception of the query, the DB server 1 (201a) and the DB server 2 (201b) perform data reference processing according to the query and reply with a data reference result, or reply with result information indicating that the data reference processing is failed (NG). The accepting server 103 waits for replies from the DB server 1 (201a) and the DB server 2 (201b), and responds to the AP server 102 according to reply contents from the DB server 1 (201a) and the DB server 2 (201b).

As shown in FIG. 5A, when both the DB server 1 (201a) and the DB server 2,(201b) reply with data reference results, the accepting server 103 determines, upon reception of replies of the data reference results from both the DB server 1 (201a) and the DB server 2 (201b), whether the data reference result 1 of the DB server 1 (201a) and the data reference result 2 of the DB server 2 (201b) match or not. In the example of FIG. 5A, since the data reference result 1 and the data reference result 2 match, the accepting server 103 responds to the AP server 102 with the same reference result indicated by the data reference result 1 and the data reference result 2. In this manner, in the “definite response mode”, when data reference results are received from both the DB server 1 (201a) and the DB server 2 (201b), the data reference results are notified to the AP server 102 after it is confirmed that a data reference result 1 and a data reference result 2 match.

Further, as shown in FIG. 5B, when both the DB server 1 (201a) and the DB server 2 (201b) reply that the data reference processing is failed (NG), the accepting server responds to the AP server 102 that the data reference processing is failed (NG) after replies from both the DB server 1 (201a) and the DB server 2 (201b) are received. In this manner, in the “definite response mode”, a failure of data reference processing is notified to the AP server 102 after the failure of the data reference processing is confirmed in both the DB server 1 (201a) and the DB server 2 (201b).

Further, as shown in FIG. 5C, when the DB server 1 (201a) and the DB server 2 (201b) both reply with data reference results but the data reference result 1 by the DB server 1 (201a) and the data reference result 2 by the DB server 2 (201b) are different, the accepting server 103 responds to the AP server 102 that the data reference results of the DB server 1. (201a) and the DB server 2 (201b) are different after receiving the data reference results of the DB server 1 (201a) and the DB server 2 (201b). At this time, the accepting server 103 may transmit to the DB server 1 (201a) and the DB server 2 (201b) control information to stop both the DB server 1 (201a) and the DB server 2 (201b).

Further, as shown in FIG. 5D, when the DB server 1 (201a) replies with the data reference result 1 in a certain time period passed from the time point of receiving the query from the AP server 102 but there is no reply from the DB server 2 (201b) in that certain time period, the accepting server 103 responds to the AP server 102 that there is no reply from the DB server 2 (201b). At this time, the accepting server 103 may transmit to the DB server 1 (201a) and the DB server 2 (201b) control information to stop both the DB server 1 (201a) and the DB server 2 (201b).

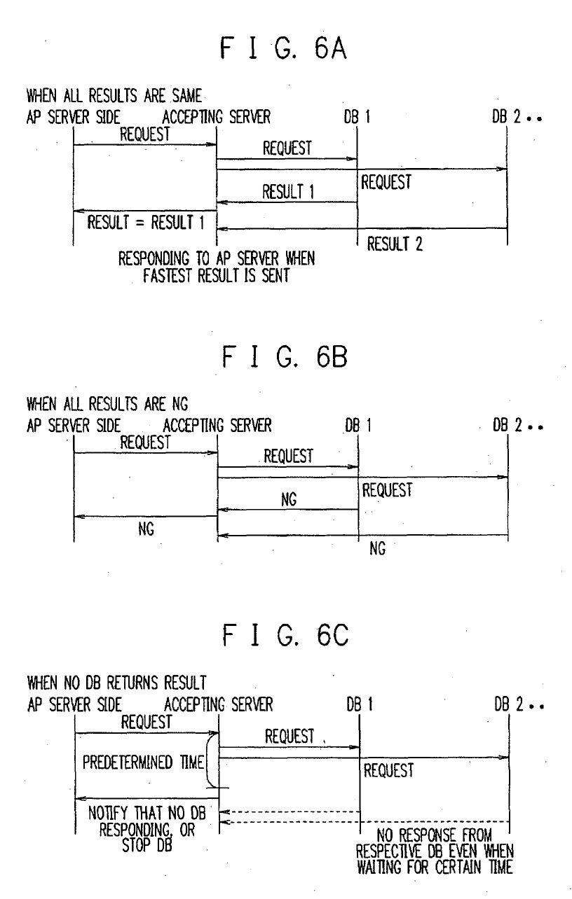

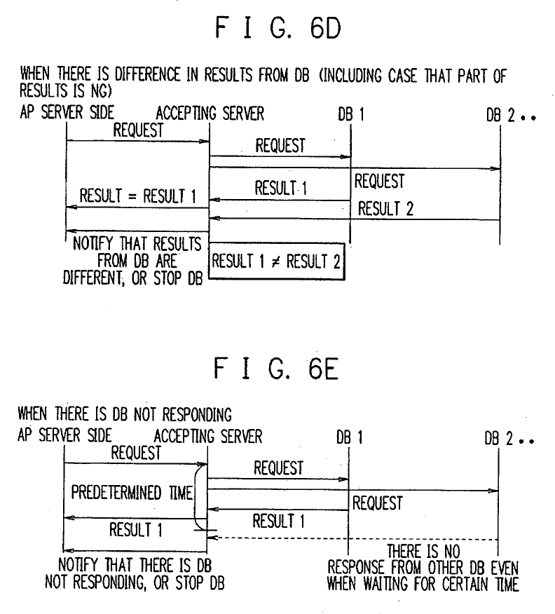

Next, with reference to FIG. 6A to FIG. 6E, operations during data update processing in the “quickest confirmation response mode” will be explained, in which the accepting server 103 responds to the AP server 102 at the time point when there is a reply first from either the DB server 1 (201a) or the DB server 2 (201b).

The AP server 102 issues a query (Request (Select or the like)) for data reference in response to a request for data reference from an in-company PC 101. Upon reception of the query from the AP server 102, the accepting server 103 transmits the query to the DB server 1 (201a) and the DB server 2 (201b) simultaneously. Upon reception of the query, the DB server 1 (201a) and the DB server 2 (201b) perform data reference processing according to the query and reply with a data reference result, or transmit result information indicating that the data reference processing is failed (NG). At the time point when there is a reply from either one of the DB server 1 (201a) and the DB server 2 (201b), the accepting server 103 responds to the AP server 102 according to reply contents thereof.

As shown in FIG. 6A, when the DB server 1 (201a) replies first with a data reference result 1 and thereafter the DB server 2 (201b) replies also with a data reference result 2, the accepting server 103 responds to the AP server 102 with the data reference result 1 from the DB server 1 (201a) at the time point of receiving the reply from the DB server 1 (201a) without waiting for the reply from the DB server 2 (201b). Thereafter, upon reception of the data reference result 2 from the DB server 2 (201b), the accepting server 103 determines whether the data reference result 1 and the data reference result 2 match or not. In the example of FIG. 6A, since the data reference result 1 and the data reference result 2 match, the accepting server 103 does not respond to the AP server 102 according to the reply from the DB server 2 (201b).

Further, as shown in FIG. 6B, when the DB server 1 (201a) replies first with result information indicating that the data reference processing is failed (NG) and thereafter the DB server 2 (201b) replies also with result information indicating that the data reference processing is failed (NG), the accepting server 103 responds to the AP server 102 that the data reference processing is failed (NG) at the time point of receiving a reply from the DB server 1 (201a) without waiting for the reply from the DB server 2 (201b).

Further, as shown in FIG. 6C, when there is no reply from either the DB server 1 (201a) or the DB server 2 (201b) during a certain time period passed from the time point of receiving the query from the AP server 102, the accepting server 103 responds to the AP server 102 that there is no reply from either the DB server 1 (201a) or the DB server 2 (201b). At this time, the accepting server 103 may transmit to the DB server 1 (201a) and the DB server 2 (201b) control information to stop both the DB server 1 (201a) and the DB server 2 (201b).

Further, as shown in FIG. 6D, when the DB server 1 (201a) replies first with the data reference result 1 and thereafter the DB server 2 (201b) replies with the data reference result 2, the accepting server 103 responds to the AP server 102 with the data reference result 1 at the time point when there is a reply from the DB server 1 (201a). Thereafter, upon reception of the data reference result 2 from the DB server 2 (201b), the accepting server 103 determines whether the data reference result 1 and the data reference result 2 match or not. In the example of FIG. 6D, since the data reference result 1 and the data reference result 2 do not match, the accepting server 103 responds to the AP server 102 that the data reference result 1 from the DB server 1 (201a) and the data reference result 2 from the DB server 2 (20lb) are different according to the reply from the DB server 2 (201b). At this time, the accepting server 103 may transmit to the DB server 1 (201a) and the DB server 2 (201b) control information to stop both the DB server 1 (201a) and the DB server 2 (201b)

Further, as shown in FIG. 6E, when the DB server I (201a) replies with the data reference result 1 in a certain time period passed from the time point of receiving the query from the AP server 102 but there is no reply from the DB server 2 (201b) in that certain time period, the accepting server 103 responds to the AP server 102 with the data reference result 1 at the time point when there is a reply from the DB server 1 (201a), and responds to the AP server 102 that there is no reply from the DB server 2 (201b) after the certain time period passes. At this time, the accepting server 103 may transmit to the DB server 1 (201a) and the DB server 2 (201b) control information to stop both the DB server 1 (201a) and the DB server 2 (201b).

Ideally, it is preferable that all the communication are carried out in the “definite response mode”, but when considering a processing time, it is conceivable that the “definite response mode” as a scheme to respond to the AP server when all results are returned from the plurality of DB servers may cause problem in practice. Thus, when there is a possibility of causing a problem, the “quickest confirmation response mode” may be selected, in which a reply to the AP server is performed at the time point when there is a quickest response from one of the plurality of DB servers. Selection of these modes is performed according to the level of security that is desired to be set.

As described above, when a query is issued for example from the AP server 102, the accepting server 103 issues the query to both the DB server 1 (201a) and the DB server 2 (201b) simultaneously. Therefore, the DB server 1 (201a) and the DB server 2 (201b) can perform the same processing based on the query on the storage device 1 (202a) and the storage device 2 (202b) simultaneously, and thereby data can be multiplied in the storage device 1 (202a) and the storage device 2 (202b) without generating a time lag as in a conventional manner. Thus, finding and prevention of unauthorized access via the external PC 400 can be performed more reliably.

Further, in this embodiment, the accepting server 103 issues the same query for data update or data reference simultaneously to the DB server 1 (201a) and the DB server 2 (201b). However, in a case that processing with respect to the same query was not performed normally on the DB server 1 (201a) and the DB server 2 (201b) side, the security is assured by notifying the abnormality to the AP server 102 side or by stopping the DB server 1 (201a) and the DB server 2 (201b).

Next, a method of monitoring the data centers 200a, 200b by the monitoring server 301 will be explained. As described above, the monitoring server 301 includes the DB comparator 3011, the storage comparator 3012 and the Log comparator 3013 as functional components for monitoring the data centers 200a, 200b.

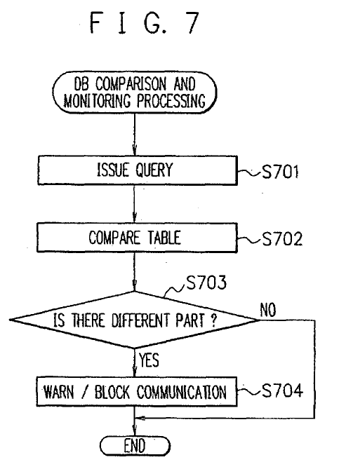

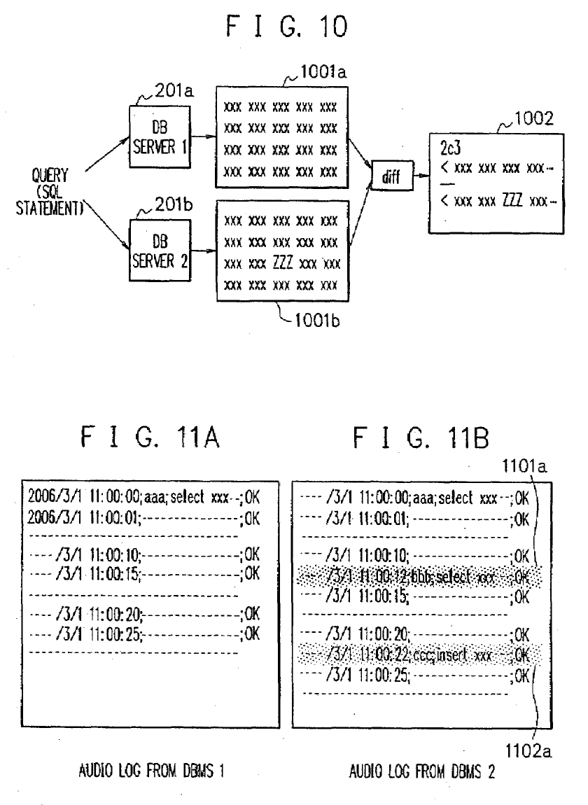

First, with reference to FIG. 7 and FIG. 10, the method of monitoring the data centers 200a, 200b by the DB comparator 3011 will be explained. FIG. 7 is a flowchart showing processing of monitoring the data centers 200a, 200b by the DB comparator 3011, and warning processing and communication blocking processing executed according to a monitoring result by the DB comparator 3011. FIG. 10 is a diagram schematically showing processing of comparing tables by the DB comparator 3011.

The DB comparator 3011 issues a query for extracting all tables to be targets of comparison to the DB server 1 (201a) and the DB server 2 (201b) (step S701). At this time, the same query (for example, Select*from tb10; or the like) is issued to each of the DB server 1 (201a) and the DB server 2 (201b).

According to the query from the DB comparator 3011, the DB server 1 (201a) and the DB server 2 (201b) search for corresponding tables from the storage device 1 (202a) and the storage device 2 (202b). Search results are outputted from the DB server 1 (201a) and the DB server 2 (201b) by text data or binary data 1001a, 1001b.

The DB comparator 3011 compares the search results 1001a, 1001b outputted by text data or binary data respectively from the DB server 1 (201a) and the DB server 2 (201b) (step S702) when the search results are outputted by text data, the search results can be compared by giving, in the case of UNIX (registered trademark) commands for example, diff (text comparison) to the monitoring server 301, and when the search results are outputted by binary data, the search results can be compared by giving cmp (binary comparison) to the monitoring server 301. Incidentally, before comparing the search results, necessary pre-processing such as sorting of data may be performed appropriately for ease of comparison.

Next, the DB comparator 3011 records a comparison result in a file 1002, and uses the file 1002 to analyze whether there exists a different part between the tables or not (step S703). As a result of the analysis, when there exists a different part between the search result by the DB server 1 (201a) and the search result by the DB server 2 (201b) (step S703/YES), the warning unit 3015 transmits warning information to the AP server 102, and also the communication blocking unit 3014 transmits control information for blocking communication to the DB server 1 (201a) and the DB server 2 (201b), thereby blocking communication of the DB server 1 (201a) and the DB server 2 (201b) with the outside (step S704).

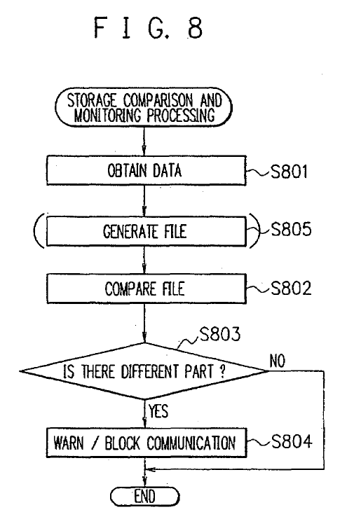

Next, with reference to FIG. 8, a method of monitoring the data centers 200a, 200b by the storage comparator 3012 will be explained. FIG. 8 is a flowchart showing processing of monitoring the data centers 200a, 200b by the storage comparator 3012, and warning processing and communication blocking processing executed according to a monitoring result by the storage comparator 3012.

As described above, in the storage comparator 3012, a method of comparing data is different depending on whether the storage device 1 (202a) and the storage device 2 (202b) manage data by means of a file system or the storage device 1 (202a) and the storage device 2 (202b) manage data as raw devices.

When the storage device 1 (202a) and the storage device 2 (202b) are managing data by a file system, the storage comparator 3012 obtains data stored in the storage device 1 (202a) and the storage device 2 (202b) (step S801), and compares data in units of files (step S802). In the case of UNIX (registered trademark) commands for example, diff command for executing comparison of data in the case of text data or cmp command for executing comparison of data in the case of binary data may be used.

On the other hand, when the storage device 1 (202a) and the storage device 2 (202b) are managing data as raw devices, giving dd command, in the case of UNIX (registered trademark) commands for example, to the monitoring server 301 causes the storage comparator 3012 to obtain data in the storage device 1 (202a) and the storage device 2 (202b) (step S801) and generate a file recording data in the storage device 1 (202a) and a file recording data in the storage device 2 (202b), respectively (step S805).

Subsequently, the storage comparator 3012 compares the file recording data in the storage device 1 (202a) and the file recording data in the storage device 2 (202b) (step S802). This comparison processing is performed by using the cmp command in the case of UNIX (registered trademark) commands for example.

As a result of comparison, when a different part exists between the file generated from data of the storage device 1 (202a) and the file generated from data of the storage device 2 (202b) (step S803/YES), the warning unit 3015 transmits warning information to the AP server 102, and also the communication blocking unit 3014 transmits control information for blocking communication to the DB server 1 (201a) and the DB server 2 (201b), thereby blocking the communication of the DB server 1 (201a) and the DB server 2 (201b) with the outside (step S804).

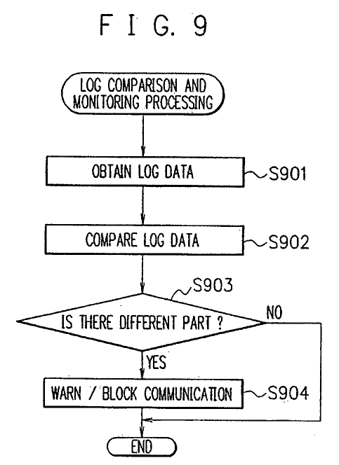

Next, with reference to FIG. 9, FIG. 11A and FIG. 11B, a method of monitoring the data centers 200a, 200b by the Log comparator 3013 will be explained. FIG. 9 is a flowchart showing processing of monitoring the data centers 200a, 200b by the Log comparator 3013 and warning processing and communication blocking processing executed according to a monitoring result by the Log comparator 3013.

In response to occurrence of an event, the DB server 1 (201a) and the DB server 2 (201b) output log data corresponding to the event. The Log comparator 3013 obtains the log data outputted by the DB server 1 (201a) and the DB server 2 (201b) (step S901), and compares the log data from the DB server 1 (201a) and the log data from the DB server 2 (201b) (step S902).

Since the same query is transmitted simultaneously from the accepting server 103 to the DB server 1 (201a) and the DB server 2 (201b), the log data outputted from the DB server 1 (201a) and the DB server 2 (201b) should be the same at the same time point. However, when the DB server 1 (201a) and the DB server 2 (201b) perform different operations at the same time point, and accompanying this a difference appears between the log data form the DB server 1 (201a) and the log data from the DB server 2 (201b), it is conceivable that unauthorized access is performed to at least either one of the DB server 1 (201a) and the DB server 2 (201b).

For example, when unauthorized access is performed only to the DB server 2 (201b) and then the data in the storage device 2 is viewed in an unauthorized way by disguising an authorized user, log data indicating that the data in the storage device 2 is viewed in an unauthorized way is outputted from the DB server 2 (201b), which appears as a difference from the log data outputted from the DB server 1 (201a).

FIG. 11A and FIG. 11B are charts showing histories of log data outputted from the DB server 1 (201a) and the DB server 2 (201b). FIG. 11A shows a history of log data from the DB server 1 (201a), and FIG. 11B shows a history of log data from the DB server 2 (201b)

In FIG. 11B, 1101a shows log data outputted when unauthorized viewing of data in the storage device 2 (202b) is performed. This log data is outputted from the DB server 2 (201b) at the time point, 2006/3/1 11:00:12. On the other hand, as shown in FIG. 11A, log data similar to that shown by 1101a in FIG. 11B is not outputted from the DB server 1 (201a) at the time point, 2006/3/1 11:00:12.

In FIG. 11B, 1102a shows log data outputted when falsifying of data in the storage device 2 (202b) is performed by disguising an authorized user. This log data is outputted from the DB server 2 (201b) at the time point, 2006/3/1 11:00:22. On the other hand, as shown in FIG. 11A, log data similar to that shown by 1102a in FIG. 11B is not outputted from the DB server 1 (201a) at the time point, 2006/3/1 11:00:22.

For example, the Log comparator 3013 compares the log data shown in FIG. 11A with the log data shown in FIG. 11B and detects difference of data as shown by 1101a in FIG. 11B or by 1102a in FIG. 11B (step S903). The comparison of log data can be performed by the diff command, the cmp command, or the like. Thus, when a difference is detected between the log data outputted from the DB server 1 (201a) and the log data outputted from the DB server 2 (201b) (step S903/YES), the warning unit 3015 transmits warning information to the in-company PC 101 on the user side to warn the user, and also the communication blocking unit 3104 transmits control information for blocking communication to the DB server 1 (201a) and the DB server 2 (201b), thereby blocking communication of the DB server 1 (201a) and the DB server 2 (201b) with the outside (step S904).

In this manner, in this embodiment, in a case that a different part is detected by comparing data in the storage device 1 (202a) with data in the storage device 2 (202b) or by comparing log data outputted from the DB server 1 (201a) with log data outputted from the DB server 2 (201b), it is conceivable that unauthorized access is performed to at least either one of the DB server 1 (201a) and the DB server 2 (201b), and accordingly, security is assured by warning or blocking of communication of the DB servers with the outside. As a method of assuring the security, other than the aforementioned one, a method to stop the DB servers themselves may be adopted.

Noted that regarding the time information included in log data, a slight difference in time occurs due to a difference in communication time or a difference between the time shown by a clock in the DB server 1 (201a) and the time shown by a clock in the DB server 201b even when the accepting server 103 accesses the DB server 201a and the DB server 201b simultaneously. Accordingly, it is preferable to add processing to absorb the difference in time such as setting an allowable range for time appropriately in advance and treating a time in this range as the same time. Further, other than the in-company PC 101, the warning may be performed also inside the monitoring center 300.

In the present invention, when there is a request for a plurality of data base servers, the information processing apparatus is configured to issue the request to the plurality of data base servers simultaneously.

Therefore, the plurality of database servers are caused to perform processing according to the request on corresponding recording devices simultaneously, and thereby data can be multiplied in the recording devices without generating a time lag as in a conventional manner. Thus, finding and prevention of unauthorized access can be performed more reliably.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

The present embodiment can be realized by the computer executing the program. A means for supplying the program to the computer, for example, a computer-readable recording medium such as a CD-ROM on which this program is recorded or a transmission medium such as the Internet which transmits the program can be used as an embodiment of the present invention. Further, a computer program product such as a computer readable recording medium on which the above program is recorded can be used as an embodiment of the present invention. The above program, recording medium, transmission medium, and computer program product are included in the category of the present invention. As the recording medium, for example, a flexible disk, a hard disk, an optical disk, a magnet-optical disk, a CD-ROM, a magnetic tape, a nonvolatile memory card, a ROM, or the like can be used.

What is claimed is:

1. An information processing apparatus connected via a communication line to a plurality of database servers performing processing according to a request from an external apparatus on data in a recording device, the apparatus comprising:
a request accepting unit accepting a request for the plurality of database servers; and
a request issuing unit issuing, when a request is accepted by said request accepting unit, the request to each of the plurality of database servers simultaneously.

2. The information processing apparatus according to claim 1, further comprising:
a reply accepting unit accepting replies indicating a processing result from the plurality of database servers; and
a responding unit responding to a requester of processing based on replies from all of the plurality of database servers.

3. The information processing apparatus according to claim 2,
wherein when the replies from all of the database servers accepted by said reply accepting unit include one or plural reply having different contents, said responding unit performs responding based on one or plural difference in the reply contents.

4. The information processing apparatus according to claim 2,
wherein when said reply accepting unit did not accept one or plural reply from one or plural the plurality of database servers within a predetermined time, said responding unit performs responding to notify absence of the reply.

5. The information processing apparatus according to claim 1, further comprising:
a reply accepting unit accepting replies indicating a processing result from the plurality of database servers; and
a responding unit responding to a requester of processing based on a reply which is accepted first by said reply accepting unit.

6. The information processing apparatus according to claim 5,
wherein when said reply accepting unit accepts later one or plural reply having contents different from contents of the reply accepted first by said reply accepting unit, said responding unit further performs responding based on one or plural difference in the reply contents.

7. The information processing apparatus according to claim 5,
wherein when said reply accepting unit did not accept one or plural reply from one or plural the plurality of database servers within a predetermined time, said responding unit further performs responding to notify absence of the reply.

8. A database management system comprising a plurality of database servers performing processing according to a request from an external apparatus on data in a recording device, and an information processing apparatus, which are connected via a communication line,
wherein said information processing apparatus comprises:
a request accepting unit accepting a request for the plurality of database servers; and
a request issuing unit issuing, when a request is accepted by said request accepting unit, the request to each of the plurality of database servers simultaneously.

9. The database management system according to claim 8,
wherein said information processing apparatus further comprises:
a reply accepting unit accepting replies indicating a processing result from the plurality of database servers; and
a responding unit responding to a requester of processing based on replies from all of the plurality of database servers.

10. The database management system according to claim 9,
wherein when the replies from all of the database servers accepted by said reply accepting unit include one or plural reply having different contents, said responding unit performs responding based on one or plural difference in the reply contents.

11. The database management system according to claim 10,
wherein when said reply accepting unit did not accept one or plural reply from one or plural the plurality of database servers within a predetermined time, said responding unit performs responding to notify absence of the reply.

12. The database management system according to claim 8,
wherein said information processing apparatus further comprises:
a reply accepting unit accepting replies indicating a processing result from the plurality of database servers; and
a responding unit responding to a requester of processing based on a reply which is accepted first by said reply accepting unit.

13. The database management system according to claim 12,
wherein when said reply accepting unit accepts later one or plural reply having contents different from contents of the reply accepted first by said reply accepting unit, said responding unit further performs responding based on one or plural difference in the reply contents.

14. The database management system according to claim 12,
wherein when said reply accepting unit did not accept one or plural reply from one or plural the plurality of database servers within a predetermined time, said responding unit further performs responding to notify absence of the reply.

15. The database management system according to claim 8, further comprising a monitoring server connected to the plurality of database servers via a communication line,
wherein said monitoring server comprises:
a data obtaining unit obtaining data in respective recording devices corresponding to the plurality of database servers respectively; and
a data comparing unit comparing data obtained from the plurality of database servers respectively with each other and determining whether respective data match or not.

16. The database management system according to claim 15,
wherein said data obtaining unit obtains, for every one of the plurality of database servers, all data in a corresponding recording device, and said data comparing unit compares all data obtained for every one of the plurality of database servers with each other.

17. The database management system according to claim 15,
wherein said data obtaining unit obtains, for every one of the plurality of database servers, target data partially from a corresponding recording device, and said data comparing unit compares data obtained for every one of the plurality of database servers with each other.

18. The database management system according to claim 15,
wherein said monitoring server further comprises:
a log obtaining unit obtaining log data indicating a processing history of the database servers for every one of the plurality of database servers; and
a log comparing unit comparing log data obtained for every one of the plurality of database servers with each other and determining whether respective log data match or not.

19. The database management system according to claim 15,
wherein said monitoring server further comprises a warning unit performing warning when respective data do not match as a result of comparing data by said data comparing unit.

20. The database management system according to claim 15,
wherein said monitoring server further comprises a database server stopping unit configured to stop the plurality of database servers when respective data do not match as a result of comparing data by said data comparing unit.

21. The database management system according to claim 15,
wherein said monitoring server further comprises a communication blocking unit configured to block communication of the plurality of database servers with outside when respective data do not match as a result of comparing data by said data comparing unit.

22. The database management system according to claim 18,
wherein said monitoring server further comprises a warning unit performing warning when respective log data do not match as a result of comparing log data by said log comparing unit.

23. The database management system according to claim 18,
wherein said monitoring server further comprises a database server stopping unit configured to stop the plurality of database servers when respective log data do not match as a, result of comparing log data by said log comparing unit.

24. The database management system according to claim 18,
wherein said monitoring server further comprises a communication blocking unit configured to block communication of the plurality of database servers with outside when respective log data do not match as a result of comparing log data by said log comparing unit.

25. A control method for an information processing apparatus connected via a communication line to a plurality of database servers performing processing according to a request from an external apparatus on data in a recording device, the method comprising:
a request accepting step of accepting a request for the plurality of database servers; and
a request issuing step of issuing, when a request is accepted in said request accepting step, the request to each of the plurality of database servers simultaneously.

26. A program product for causing a computer to execute a control method for an information processing apparatus connected via a communication line to a plurality of database servers performing processing according to a request from an external apparatus on data in a recording device, the program product causing a computer to execute:
a request accepting step of accepting a request for the plurality of database servers; and
a request issuing step of issuing, when a request is accepted in said request accepting step, the request to each of the plurality of database servers simultaneously.
